(19) United States
(12) Patent Application Publication
(10) Pub. No.: US 2021/0042826 A1
(43) Pub. Date: Feb. 11, 2021

(54) DECENTRALIZED DISTRIBUTION SYSTEM SUBSTANTIATED BY CRUDE OIL RESERVES ON A BLOCKCHAIN NETWORK

(71) Applicant: William Garrett Pete, St. Cloud, MN (US)

(72) Inventors: William G Pete, St. Cloud, MN (US); Lucas James Hoath, Apple Valley, MN (US)

(73) Assignees: William Garrett Pete, St. Cloud, MN (US); Lucas J Hoath, Apple Valley, MN (US)

(21) Appl. No.: 16/536,399

(22) Filed: Aug. 9, 2019

(51) Int. Cl. G06Q 40/04; H04L 9/32; H04L 9/30; H04L 9/06; G06Q 20/36

(52) U.S. Cl. CPC G06Q 40/04; H04L 9/3252; H04L 9/3073; G06Q 2220/00; G06Q 20/3674; H04L 2209/38; H04L 9/0637

(57) ABSTRACT

Disclosed herein is a commodity distribution system based on the use of a blockchain electronic currency substantiated by liquid crude oil as bullion. Also included are methods for issuance and circulation of the previously mentioned electronic currency through the issuer's website. Outlined herein is a self-regulating method of autonomously maintaining the required reserve of crude oil assets that substantiate the value of the aforementioned electronic currency. The generated electronic currency will be issued into circulation in an amount equal to the reserve of crude oil assets supporting it. The blockchain system described herein relies on an ECDSA-based currency system to manage and substantiate backing of orders and transfers of this electronic currency per a decentralized computer network.

### DETAILED SPECIFICATIONS

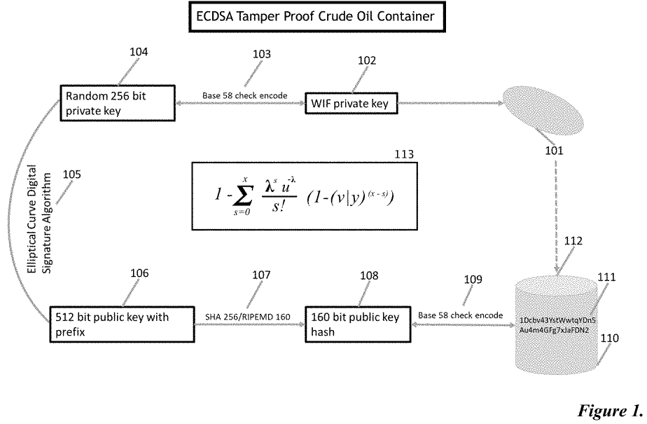

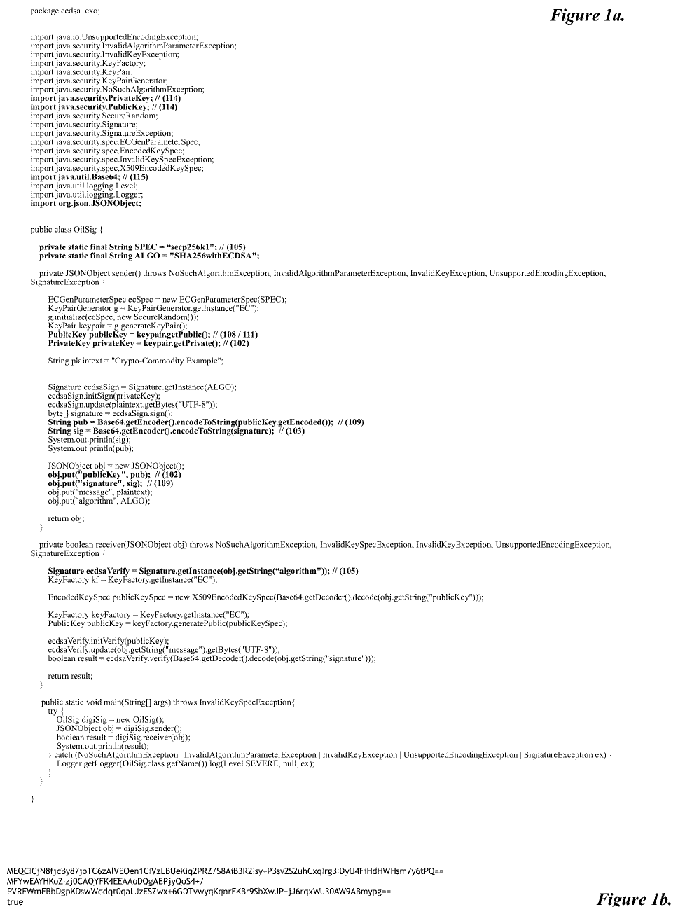

(7) Claim 1 is the use of an elliptical curve digital signature algorithm to create and secure encryption key pairs in the use case of a crude oil backed digital asset as outlined in FIG. 1 and FIGS. 1a & b and subsequently demonstrated by the potential results of the compiled Java source code in FIG. 1a.

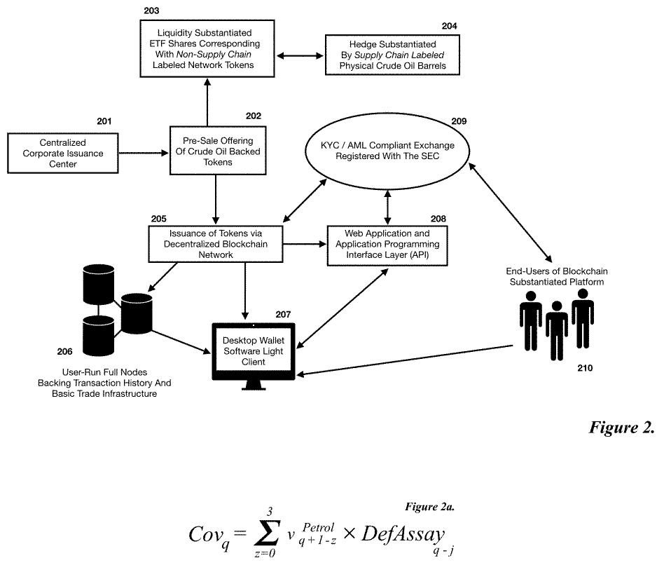

(8) Claim 2 is the use of petroleum oriented analysis of covariance models (ANCOVA) as demonstrated in FIG. 2a to allow mathematic allocation of crude oil resources to appropriate containers in a mannerism similar to or equivalent to an assay number printed on bullion.

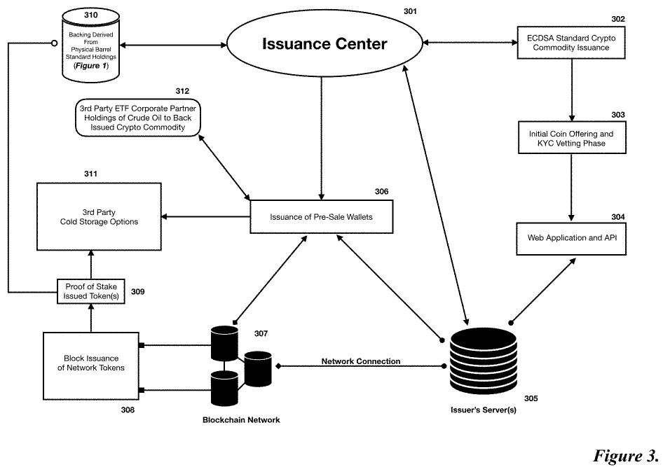

(9) Claim 3 is the issuer purchasing an initial reserve of physical oil or ETF shares from a broker or a seller via contract as per FIG. 3. The issuer will request the issuance of an electronic commodities trade which would be valued from the Issuance Center using the electronic currency using the given modules outlined in FIG. 3. the issuer may purchase any additional amount of the crude oil reserve asset from a broker or seller that is sufficient to request an equivalent to. The issuer's issuance and data management center verifies the existence of all assets from the issuance center itself. If the amount of the reserve asset is acquired from a broker or a seller the oil or ETF shares need to be: sufficiently and efficiently technically possible, sufficiently and efficiently able to support the requested amount, sufficiently and efficiently be able to request, monitor, manage, inventory, and assess the current value of all of the direct materials and product on hand to include the ETF shares, sustain the issuance of the electronic value of the product which would be equivalent to the assets on hand as well as in the reserve, sufficiently and efficiently increase the volume of the issued ETF shares according to the business plans of the issuer Issuance of the electronic valuables and non-electronic valuables will be automatically purchased by the the issuer data management and issuance center which will also release an amount of additional backing in lieu of the electronic valuables equivalent in the reserve of the assets. If the value of all or part of the amount that the broker or seller supplies to the issuer is insufficient the reserve of the remaining assets will be used to transfer the backing of the detected electronic valuables from the issuer's pre-issuance wallet to the issuer's issuance wallet in the event that this is needed and sent to the settlement department. the issuer, may then self-distribute the issued electronic currency to one or more users or parties operating on the system. The issuer data management and issuance center will monitor the current value of the assets, and the asset reserve and the total overall volume of the issued electronic commodities total value.

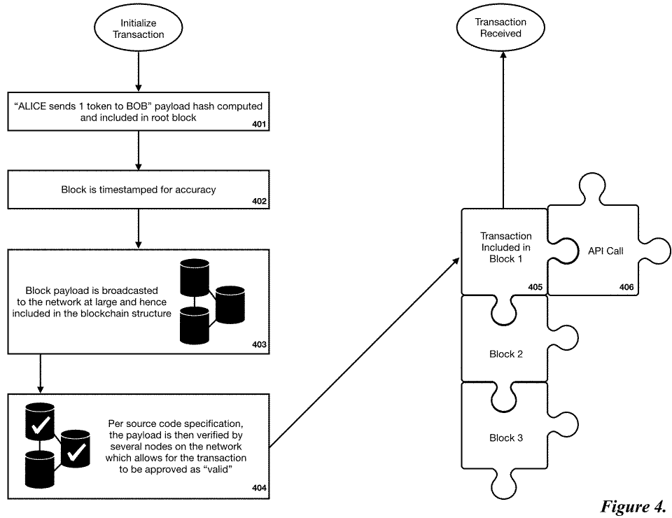

(10) Claim 4 illustrates the public and private keys derived from the ECDSA example in FIG. 1 will be implemented at large in an online, blockchain-based distributed public ledger allowing for transactions to take place on a person-to-person P2P basis as well as a business-to-business basis B2B while also facilitating for an option for business entities to trade with or interact with personal entities or vice versa. FIG. 4 expands on the concept of a blockchain describing how a private transaction that takes place between two entities is then broadcasted on an online public network.

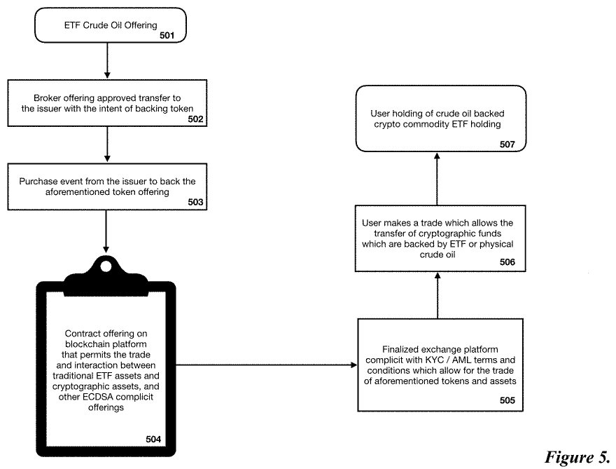

(11) Claim 5 illustrates the issuer purchase of an initial reserve and or stock pile of oil or ETF shares of oil from a broker or a seller as per FIG. 5. Client requests issuance of an electronic valuable from the the issuer data management and issuance center (e.g., an electronic commodities currency) using the module provided. The issuer data management and issuance center then verifies the existence and amount of the reserve asset to make sure it is sufficient enough to substantiate the requested issuance of all electronic commodities valuables. The issuer's data management and issuance center issuance center releases an amount of the electronic commodities valuables equivalent to the value of all or part of the amount of the reserve assets. For example, transfers the electronic commodities valuables to the client's issuance wallet on the network. The client may the either do the following with the electronic commodities currency [sell the issued electronic commodities currency to one or more users the current rate of the electronic commodities currency set by the client. Or hold the electronic commodities currency] Client may purchase an additional amount of the reserve assets that the issuer will hold on hand. [There must be sufficient reason to request an equivalent increase in issuance of the electronic commodities valuables to clients that have already been released.]

### Scope of Technology:

(12) The present invention generally relates to payment systems based on use of electronic commodities currency backed by ETF shares or physical crude oil from a U.S. based company or trade system. All the systems and methods that the issuer has developed for the generation of the cryptocurrency and issuance of the blockchain-based electronic commodities currency which is substantiated by a reserve of assets that the issuer holds.

### Vision and Concept:

(13) Recently the notion of private currency embodied through electronic currency (in particular, cryptocurrency) has become increasingly popular and also a highly volatile market internally and externally to the economy. The value and potential of this currency and market has not yet been fully realized. Various cryptocurrencies have heralded a new era in economics. Shares of each currency in volume, moved every day; as well as the value of the individual currencies, themselves have increased dramatically.

### (14) The Following Technical and Fiscal Advantages Exist Currently in the Crypto Economic Market:

An extremely high level of safety in the transfer of funds as well as the funds themselves. Control over expenditures of the specific funds as well as transactions.
1) No unauthorized withdrawals of funds from accounts not approved by the account holders.
2) Cost efficient to transfer any desired value bypassing intermediary agencies as well as any associated costs that would have been incurred with those agencies. Mitigates delays that came from traditional value transfer applications or intermediaries. For example; credit cards, debit cards, checks, money orders, and also any and all bank transfers (Wire, ACH, etc.). Fiat currency require validation, accounting, and/or processing by two or more approved and accredited financial institutions.
   (16) The Claimant has Identified the Following Cryptocurrency Disadvantages which Include:
1) All cryptocurrencies are based on blockchain technology. This guarantees security to all transactions made through the particular cryptocurrency organization. The result of this is investigations by financial and tax regulatory authorities.
2) The issuance of cryptocurrencies is decentralized and due to this business model cryptocurrency organizations are not subject to stringent regulation.
3) Cryptocurrencies are volatile due to the fact that most cryptocurrencies have no underlying assets to back the value of the organization itself or the crypto currency which that particular organization holds. This in turn gives no relationship to the economy directly so there is no earnings stream, holdings of stocks or bonds, or ability for consumers to consume commodities.

(17) The issuer of such a currency sees that the advantages of cryptocurrency to the economy and future potential to be a significant economic asset in the future is significantly overshadowed by the high volatility and lack of the currency being backed by a dollar valued asset. High volatility will lead to expenditures eventually exceeding banking processing fees for the organization when transferring funds to and from cryptocurrencies with no revenues being returned to the organizations itself as well as no impact on the overall actual economy. Current account holders accepting cryptocurrency is unpredictable and due to the high volatility has a rate fluctuation which is unpredictable. This results in a loss of funds which exceed the value of the fees incurred by the crypto currency organizations from credit cards. Due to these cryptocurrencies are not used as a means of payment or a valued acceptable currency for actual products and services offered in the economy. The issue of the high volatility of cryptocurrencies as well as the currency having no asset backing has not been solved. There is not only a need but also a necessity for developing a system and means of a method which is focused on backing cryptocurrency by ETF shares of oil or physical holdings of oil. This will yield in a positive effect by using cryptocurrencies backed by assets that add value to the economy and trade systems. Resulting in a mass market between cryptocurrency organizations, buyers, sellers, and banks. As well as an overall healthy relationship between cryptocurrency organization and regulatory agencies.

(18) In order to address the high volatility of cryptocurrencies the issuer will back a currency by a commodity that has a substantiated real value. In turn supporting the currency and coins available by the amount of asset held. State currencies which include the world reserve currencies that are regulated by agencies have strayed from a defined value backing standard. This standard of backing is a support mechanism for the health of a currency as well as the organization or nation that holds the rights to the currency itself as well as all account holders.

(19) There is a big issue with the failure of oil-backed currencies which is caused by a shortage or hard to acquire ETF funds or oil this became insufficient for substantiating currencies used for certain international settlements.

(20) It is fair to state that the limitedness of oil and ETF funds is leading to the impossibility of creating a global oil-backed currency for international finances and also international finance organizations. The reason for this is that their circulation grows faster than the oil refining and mining industry can process on the planet.

(21) Oil and ETF shares themselves play a role of a currency in themselves. Oil and ETF shares remaining a commodity and an asset is used as a means of payment at the same time. Unfortunately, there are several substantial disadvantages to this which includes:
1) The ability to withdraw physical oil from the system could cause a collapse of the actual system itself in the event which there is an increase in the demand for oil or ETF shares.
2) The restrictions set on oil circulation which is set by each individual state government could complicate the operations of the system.
3) As a commodity, oil, as part of deals, is subject to taxation. This causes circulation-related expenditures upon the physical purchase of oil and ETF funds and also selling oil.

(22) There are not many systems in place which reduce the risks attributed to the volatility of a cryptocurrency. There needs to be a multi-currency system in which there are proper payments and conversions of those payments. This overall system would not regulate the initial issuance of the cryptocurrency itself. There needs to be a solution to the absence of the backing of the currency which is substantiated by the physical asset held by the issuer This will enable the users to use the advantage of which cryptocurrency was designed and created for in the first place. In turn avoiding the risks related to the currencies.

### Drawings & Figure Reference:

### (23) Approach and Innovation Description

(101) This represents the lid to be sealed on a standard container designed to store and transport oil via various means presently feasibly in a blockchain backed supply-chain.

(102) In standard secp256k1 (ECDSA) compliant Wallet Import Format (WIF) found in other cryptocurrencies, the label will be affixed to the outlined lid found in illustration 101 which is designed to secure and associate value entanglement between a cryptographic private key and the reserves of liquid crude oil found within the aforementioned container module.

(103) Base-58 binary-to-text encoding is used within this step to ensure that the WIF private key in the previously mentioned step is properly encoded to a secp256k1 Elliptical Curve Digital Signature Algorithm (ECDSA) standard.

(104) At this step we have a finalized SHA-256 standard private key that will be used to transfer the ownership of the container and viewable by the current owner.

(105) The aforementioned SHA-256 private key is then processed through secp256k1 ECDSA algorithm to ensure that this container can only be transferred or ‘spent’ by its rightful owner. Which is the premier security feature of blockchain oil-as-bullion.

(106) At this step we are granted a SHA-512 public key that allows other individuals on the P2P network to view the contents of any given container and it's owner(s) while also providing means to send and receive value propagated by liquid-able crude oil.

(107) RACE Integrity Primitives Evaluation Message Digest 160-bit (RIPEMD-160) allows the aforementioned public key to be processed into a hash that can be re-appropriated to a network-standard address.

(108) At this step we are granted a 160-bit public key address that provides security to coin holders, senders, and recipients while allowing a transparency standard on the open P2P network.

(109) A final Base-58 or Base-64 check binary-to-text encoding is used within this step to ensure that the public key is also properly encoded to ECDSA standard allowing for P2P network security.

(110) This is the final physical container which will house the liquid crude oil needed to substantiate value on the network.

(111) The public key is then printed physically on the exterior of the container to allow for easy supply chain management and warehouse storage.

(112) Drawing from steps 101 & 110 we then seal the container at this level which consolidates a regulated amount of oil found within the container such as a standard international container or DOT-111 or TC-111 tanker.

(113) Here we have an equation that allows us to calculate the possibility that an attacker creates a dishonest alternate chain to try to counterfeit or re-label crude oil containers maliciously. The example here is created from the perspective that the sender of a token is the attacker attempting to convince the recipient that he paid them for a given amount of time while switching back the transaction at a given point in the future to cause a chargeback event allowing the malicious spender to double spend his tokens by using a fraudulent side chain designed to allow double spending.

Taking into account the Poisson density for each stride the attacking sender makes in the direction of defrauding the compliant receiver, after running the results of this equation we find that the possibility the attacker can keep up with his fraudulent blocks being added to the network drops off exponentially at ‘x’ and once we solve for ‘y’ the probability of an attacker succeeding in defrauding the receiver drops to around 0.1% making it more advantageous for the sender and receiver to spend their time devising economically productive solutions instead of regressing to fraud to profit one side.

### (24) Description of Technical Implementation

(114) As illustrated in FIG. 1a we have established a Java program which outlines an implementation of the ECDSA algorithm as it may pertain to crude oil in various applications. Emboldened in the code's comments are the numeric cross-reference identifiers that tie the various aspects of the program to the pseudocode flowchart present in FIG. 1. It is possible to implement the elliptical curve using multiple encoding outputs, languages, and blockchain platforms, but the underlying cryptography referenced in FIG. 1 remains constant for the purpose of establishing the claimed functions. Abstract vs. applied solutions for ECDSA in the crude oil sector will be generally derived from the core technology which allows for pairs to be generated utilizing cross-platform libraries present in the most prominent languages today. In the case of FIG. 1a the public private key pair generation and subsequent text output to a string are found in the java.security library.

(115) To achieve the final output to the console which it is required to utilize the JSON library found within org.json in tandem with java.security.util.Base64 which allows proper formatting and console output of the public key (MEQCIC . . . ) followed by the private key signature (MFYwEA . . . ) as described in FIG. 1b.

(116) Producing such results as described in FIGS. 1a & b are the primary claim present in this application as using the output per FIG. 1b is the value propagation that comes from the software application described throughout this document in a blockchain application. It is imperative to emphasize that this output can be achieved both using a blockchain and also in a standalone program as demonstrated in FIG. 1a as claimed. The intent of the application is to provide a foundation for the creation of crypto-commodities that derive their value from public and private key pairs on an online network that allows software to denote content and value of content in marked containers.

(117) Through describing the basic software function of this program, a foundation is provided for the creation of such software as outlined in FIG. 1 furthermore implemented in FIG. 1a and then executed in FIG. 1b. This represents a unique use for a program which has been created for prior use in internet security exclusively, the illustrations show clear intent to take the outputs of this program and attribute them to a physical object, in this case, a container of crude oil which may assume various sizes and shapes.

### (25) Corporate Compliance & Business Model

(201) The following flow chart found in FIG. 2 describes a centralized issuance model and is presented to us with the aforementioned the issuer being represented as the issuer

(202) Follows this centralized issuance event with a subsequent Initial Coin Offering (ICO) pre-sale stage which is presented in the flow chart.

(203) The corporate issuance model from here is guided and substantiated through corporate-held exchange-traded funds offered and secured through registered brokers via existing National Securities Exchanges registered with the SEC under Section 6 of the Securities Exchange Act of 1934.

(204) In tandem with this liquidity derived from backing tokens with traditional assets offered on traditional stock exchanges, there is a supply chain relationship initialized between the Proof-of-Stake interest reward network, ETF brokers, and finally the issuer in efforts to label physical crude oil containers, namely 42-gallon containers used as the standard of most crude oil trade today; pursuant to the ECDSA standard outlined further in FIG. 3 presented later in this document. The following algorithm displays the covariance relation between the assay of speculative investment in crude oil reserves taking into account the hedging demands of producers in a broker-dealer petroleum market; henceforth weighing risk against assets held in the hedge.

In tandem with this liquidity derived from backing tokens with traditional assets offered on the stock exchange, there is a supply chain relationship initialized between the Proof-of-Stake interest reward network, ETF brokers, and finally the issuer in efforts to label physical crude oil containers, namely 42 gallon increments within DOT-111 & TC-111 train cars; pursuant to the ECDSA standard outlined further in FIG. 3 presented later in this document.

(205) This stage gives finalized issuance of publicly traded tokens on a Proof-Of-Stake blockchain network which is henceforth recorded on a decentralized network of nodes running the core software.

(206) Illustrates full nodes running the blockchain core software which will be responsible for maintaining a decentralized digital ledger tasked with logging digital crude oil trades for regulators.

(207) This data generated by the network becomes apparent and available to end users through an application designed as a computer oriented client.

(208) A web application layer is provided for 3rd party developers to access various network features via an API call to the core blockchain network & software layer(s).

(209) Represents an online exchange geared towards digital assets and commodities otherwise known as cryptocurrencies, which has registered in compliance with the Securities Exchange Commission and utilizes the data from the blockchain software to remain compliant with current Know-Your-Customer and Anti-Money Laundering standards.

(210) Represents the end-user interacting with the network via the desktop client or exchange platform on their mobile device or tablet which could potentially substantiate trades for monetary value in United States Dollars. This finalized network outlined in FIG. 2 will then be provided to users through the the issuer website which allows for the download of a desktop, mobile, and browser-based client, henceforth making it possible to exchange commodities in a manner that produces data.

### (26) Issuance Center Business Model, Claims and Technology

(301) We will find a corporate-approved issuance center which could be either a company owned establishment tasked with the logging of standard crude oil containers on the blockchain or also an approved partner who have agreed to work within the specification of the patent.

(302) is the first phase of bringing the sealed container of oil online through our patented labeling process that is further outlined in FIG. 3—at this stage we create an ECDSA complicit cryptocurrency to represent the oil shares & containers.

(303) Represents the know your customer (KYC) and anti-money laundering (AML) vetting process taken before issuance of the pre-sale wallets to their rightful owners via email.

(304) This phase illustrates the offering of a web application and API service allowing for upstream data regarding user accounts to be pulled from the corporate server. Henceforth, providing the user with their ICO wallet balance.

(305) The first initialized corporate mainframe server is shown here and designed to process ICO orders as the first smart-contract backed, machine-based mediator in the blockchain network issuance model. It is also tasked with maintaining the genesis block, and the distribution of pre-sale wallets within our wallet issuance phase.

(306) Represents the issuance of tokens on a decentralized network that will be eventually pulled downstream by the smart contract model present on the corporate servers. Subsequently, these pre-sale wallets will be matched with the amount purchased during the ICO and compliance vetting process. This is a non-blockchain data set that could be represented well in the form of a spreadsheet, JSON, or XML objects.

(307) In this portion it is the illustrated event of the final main-net launch which will encompass the finalized user-accessible wallets and trading features found in a typical cryptocurrency, along with the expected ECDSA dependent features that allow account security and prevent double spending of tokens, man in the middle attacks, DDoS, and finally brute force measures against the network at large.

(308) Represents the block model of token issuance beyond the pre-sale wallets which will allow nodes to earn coins via an energy consuming proof-of-work model that secures and maintains transactional integrity of the network at large in a decentralized manner. Blocks may be issued to these miners at a rate set in the original algorithm as to limit the supply of coins found in the market and possible within the network.

(309) Allows for users of this aforementioned system to gain a pre-determined proof-of-stake interest on their existing holdings within this coin's network. The coins issued via this mechanism will be subsequently backed by physical containers of crude oil held by the issuer

(310) The physical containers held by the issuing corporation or entity known as the issuer will be reserved for the tokens earned via proof-of-stake to incentivize long term holding of crude oil as bullion. Henceforth, providing an environmental benefit and incentive as the oil will be stored instead of traded into energy production.

(311) Will represent 3rd party technologies designed to store coins offline and provision a bullion-like ecosystem of trade that involves the trade of a physical, offline device which would maintain the private keys associated with containers of oil and subsequently the corresponding network tokens.

(312) Represents external corporate partners with a pre-existing agreement coded into the pre-sale smart contract allowing their compliance and furthermore participation in the network due to their application of the FIG. 1 ECDSA supply chain model which will be used to convert ETF-based oil funds to blockchain supply models which can be easily imported and studied by market and data analysts.

In FIG. 3, as represented above we are given a clear outline of the corporate relationship to the client and the desktop & mobile blockchain wallet software that allows the user to securely move crude oil holdings through the internet.

### (27) Blockchain Transactional Model

(401) Transaction is initialized and the amount of tokens designated by the sender, in this representation by “Alice” is henceforth transacted to “Bob” while the payload hash of this transaction is then digitized and included in a record of such happening.

(402) This transaction is included in a block hash and timestamped for accuracy, therefore allowing for the overall structure of the blockchain to be based upon time oriented trades which occur between two or more users.

(403) This block payload is then broadcasted to the network at large and hence included in the blockchain structure which is then downloaded by participating nodes on the network.

(404) This payload is verified by the specified number of nodes needed to secure the transaction as “valid” on the network. This allows fulfillment of the blockchain model and protects end users against chargeback transactions and otherwise fraudulent ledgers being presented to them en lieu of a previously processed transactional occurrence on the network.

(405) The transaction is included in a network broadcasted block and then allowed to be spent by the receiver which henceforth completes the transactional occurrence from “Alice” to “Bob” which will be included in a network recognized block.

(406) This represents the relation of a 3rd party API integration into the main system at large allowing for developers to pull and interact with transactions that have been published to the network—which will open the possibility for development of solutions beyond the blockchain and encapsulate web 2.0 solutions for the share and interaction of information via application interface.

(28) The issuer will purchase an initial reserve of physical oil or ETF shares from a broker or a seller via contract.

(501) A crude oil offering is selected by the corporate entity known as The issuer Henceforth allowing for the cryptocurrency to be consolidated as a crude oil backed crypto-commodity.

(502) This step outlines a transfer of value occurrence between The issuer and a registered oil broker allowing for the crypto commodity to be backed per specification by the issuance model.

(503) A purchase event is initiated in the form of a financial transaction involving U.S. Dollars being transferred from The issuer traditional banking asset holdings to the approved broker.

(504) Here we have a smart contract offering which is to be coded and offered on a secure blockchain either proprietary to, or produced by a third party open-source offering complicit with ECDSA cryptography. At this point we will be able to associate physical oil holdings or ETF shares found on a traditional market. This allows existing blockchain assets to be traded in exchange for crude oil backed tokens on an open market.

(505) Tokens issued and backed by the smart contract at this point are able to be traded on complicit exchanges at large. This allows for liquidity from a broker-dealer standpoint as described in (204) while also provisioning necessary covariance between the physical oil and the the tokens.

(506) At this step, trades and exchanges can be initiated at ease by users looking to exchange existing digital blockchain assets for a stabilized, regulated crude oil backed cryptocurrency; without having to worry about external commodity backing of their assets being dissolved or traded without their permission.

(507) The concept of user-held oil as bullion is fully realized at this step as the end user will be holding a token directly tethered to a given amount of crude oil.

(29) The Issuer will Request the Issuance of an Electronic Commodities Trade which would Assign Initial Value from the Issuance Center

(601) The issuance center responsible for the distribution of the coins sold in the initial coin offering process becomes present as the private and 3rd party held ETF holdings are processed to be serialized and entered into a blockchain supply chain.

(602) Privately held oil in the reserves of The issuer possession and assay will be first to enter the supply chain on the basis of provisioning a risk hedge against losses that could be potentially realized by 3rd party transport or storage issues.

(603) Third party crude oil exchange traded funds are paired with the cryptocurrency issued using the covariance model outlined in (204) to keep an assay risk hedge in the broker-dealer market.

(604) The aforementioned oil reserves are entered into a pre-issuance supply chain escrow that tallies oil that has been filled into a container of variable standard size. This is then reviewed by the issuance center and processed onward to serialization.

(605) At this stage we implement the process outlined in FIG. 1 which allows for serialization of the containers before they are subsequently entered into the blockchain.

(606) At this stage the serialized container is inserted into a block which is then implemented into the blockchain-based supply chain as a data point allowing for the container to be traced via economic trade models and physical geotagging models.

(607) A public key address visible to all users of the blockchain software is then published online to the network via the blockchain.

(608) The container of oil receives time-based confirmations from nodes on the network as a verified transaction. To appear on the network as ‘sent’ only one confirmation from other nodes will be necessary.

(609) Once the transaction is confirmed entirely as ‘received” following 6 or more confirmations, it becomes traceable by the receiving user.

### Summary of System:

(30) The current system enclosed within this document provided by the issuer provides the systems and also the methods needed for the generation and issuance of a fully backed functional electronic commodities cryptocurrency that is free from pre-existing market problems and issues that plague the value and use ability of all cryptocurrencies. The system eliminates high volatility with the help of an “oil standard”. This also lowers the volatility of oil and ETF funds making them more secure and useable for the cryptocurrency that the issuer will provide from an intangible asset.

(31) The issuer's invention enclosed illustrates a substantiated currency where the issuance apparatus will not be creating debt. Due to this there will be no problem of a shortage of the oil or ETF shares backing the cryptocurrency.

(32) The issuer provides a stable and viable electronic commodities cryptocurrency with low-volatility. This renders the described currency a commodity.

(33) All the aspects that the issuer presents for the invention will solve the problem of protecting the issuance of the substantiated electronic commodities currency that would be undervalued in this market. Money from a fiat currency which would be overvalued for this system would make a non-fixed amount of assets which substantiates the reserve of valuables that the issuer will hold. (for example, all oil reserves or ETF shares held) This amount would change on a monthly basis depending on the demand for the substantiated money from the offered electronic commodities currency. When a purchase of the electronic commodities currency via the fiat currency provided for the current system developed by the issuer There is in turn a purchase of the substantiating valuables so the reserve of oil and ETF shares that the issuer will hold will increase. If money is withdrawn from the system by selling the electronic commodities currency. Each client and account holder will make clear the amount which corresponds to the exact amount of the substantiating valuable in oil or ETF shares. The exact among of the valuable will be withdrawn from the reserve that the issuer will hold and will be sold at the current market price of oil or ETF shares valued. After this the client or account holder will receive the fiat currency at its current rate at the moment of sale.

(34) The currently enclosed system developed by the issuer is linked to oil and or ETF shares. There-in exists no issue of a shortage of oil or ETF shares. Due to the fact that the substantiating oil stock will change within the compliance of all clients' orders for the purchasing and selling of the electronic commodities cryptocurrency. All the transactions will be carried out immediately which will be realized through a specific in house reserving mechanism based on the application of a mathematical model that will incorporate the elliptical curve signature and the SHA based currency system that will be an ECDSA program. This will allow a lower turnover in oil or ETF shares.

(35) The organizational solutions used by the issuer of the current embodying project enclosed herein will initiate a high circulation speed a low-cost margin for the integration of this system with existing financial institutions.

(36) The issuer's users will include individuals, legal entities, and also state institutions for the available countries that participate in the issuer's mission and initiative of the alternate financial system offered through this program which is completely different from the current system that exists currently.

(37) The issuer's system for the issuance and circulation of the electronic commodities cryptocurrency offers the potential for backing a currency by a liquid asset such as “gold standard” adopted by the United States in 1873. Instead of the “gold standard”, the issuer will offer an “Oil As Bullion Standard” to back the current cryptocurrency which will also add to the nation's GDP as it will be a fiat based tradable currency inside of the United States and also internationally.

(38) The computer-based payment system that carries out electronic settlements using electronic currency that is substantiated by a reserve of assets which The issuer, holds comprises of a management module. This will be ran and operated by a computer processor. This processor is configured to create and manage the wallets of electronic currency that the clients hold. There is a system operator for the computer processor which monitors the pool of clients. This person and also the computer processor conducts the electronic currency payment transfers and transactions between the electronic commodities currency and the multiple wallets.

(39) All of the information about the transactions will be recorded and documented in a private blockchain-based settlement network. Which will manage information about the reserve of assets withstanding that backs the electronic commodities currency. The control measures set in place will take place in real-time purchase of assets. This will either be on a local or external market. Which will be in amount that substantiates the issued electronic commodities currency at each point of sale in real-time. The issuance center will receive real-time information from the management module pertaining to the amount of assets that was purchased substantiating the electronic commodities currency. The issuer will conduct the centralized generation and monitored issuance of the electronic commodities currency. Then in turn putting the currency into circulation. The generation and processing of all the electronic commodities currency will be managed in a single block. This will create a block within the blockchain which uses miner operations (manufactured, monitored, and kept in house by the issuer).

(40) The miner may generate the maximum possible amount of allotted electronic commodities currency. The generated electronic commodities currency will be issued into circulation by the issuer, for the amount of 5 or less of the reserve of assets that the issuer will possess. When the value of the reserve of assets that the issuer holds reaches its predicted break-even amount (which will be calculated by the computer processor). The amount of assets currently on the market at this time will be sold or purchased to cover the remainder of the substantiated issued electronic commodities currency. The issuer has developed mathematical functions which account for moments of distribution, receipt of clients receiving issued electronic commodities currency, purchase and selling orders, and the backing of the electronic commodities currency by “oil” or a fiat currency.

(41) The orders will be transmitted to the management module. All purchase or sell orders will be added or subtracted from the total amount of assets that the issuer holds.

(42) The electronic commodities currency is a cryptocurrency which is ever-changing due to the actual secondary market of oil. The unit of counting the electronic currency is accepted as equivalent to an

amount of oil. This amount and value of the currency held that is backed by the liquid assets that the issuer, holds will be calculated on a monthly basis. The shares backed for the month will be calculated off of the price of oil at the last day of the previous month. This will allow for the assets that the issuer holds that back the electronic commodities currency to be fair valued at the market price of oil.

(43) The management module that records and manages the payment system will be configured in order to connect to the vault which stores the oil or ETF funds reserve. This module will connect the brokers that the issuer has either employed or is dealing with that handle the purchasing and or selling of oil or ETF share on the external market at market value.

(44) The mathematical functions that the issuer, has developed will be applied within the system's work accounts for the distribution of the electronic commodities currency. These functions will define the order type at random. In turn the size of the orders and the initial purchase or sale of the electronic commodities currency will be defined by a logarithmically distribution code developed by the issuer where, prime numbers are assigned to all orders for selling and purchasing of electronic commodities currency.

(45) All of the purchase or sale numbers will be double encoded by an internal Godel number-based system model that is expanded upon and also added to by the issuer, in order to secure our clients sales as well as all of the issuer's purchases of assets. This Godel numbering based system will also be applied to the SHA double encrypted algorithm to ensure that the private host address (i.e. the issuer) as well as all of the clients addresses and passwords are secured. All of this will be mapped on our elliptical curve signature.

(46) The computer-implemented method for generation and issuance of a block chain based electronic commodities currency for a payment system of the issuance center will create a block within a blockchain. That will incorporate mining operations to generate maximum possible profit and usage of all assets. The pre-issuance wallets created also by the computer will be copied by the computer. All of this will operate in the the issuer's data center. All issuance wallets will be created within the data center as well.

(47) The data center will ensure that the generated electronic commodities currency is able to be substantiated by a tangible liquid assets from the reserve of the system. The data center performs the primary issuance or the substantiated portion of electronic commodities currency, thus a portion of the generated electronic commodities currency, from the pre-issuance wallet and also the issuance wallets from the data center will translate the amount of the electronic commodities currency which corresponds with the 5 less the amount of the physical liquid assets that the issuer, holds thus making all of the issued electronic commodities currency available for purchase by the clients of the issuer. If the issuer receives a 5 less then the amount of the physical asset from a client, the portion of the electronic commodities currency from the clients issuance wallet will be communicatively linked by the issuer's settlement network.

(48) The above method uses a block within a private blockchain. The electronic commodities currency is generated by the the issuer's issuance center using a proof-of-stake or proof-of-work algorithm.

(49) The method for generation and issuance of the blockchain-based electronic commodities currency via the settlement network will consist of a geographically distributed network which will operate a bare minimum of two communicatively linked nodes. This base number is to ensure efficiency in the issuance and the overall data management process put in place by the issuer in the data center. All the nodes operating on the the issuer settlement network will be controlled by the administrative operator of that particular system operating the given node. The settlement network is configured so that at least two nodes will always be available to facilitate transactions between the issuer and its clients for the issued electronic commodities currency at all times.

(50) Electronic commodities securities currency (virtual funds of the issuer) Electronic commodities securities currency stored in the wallets of the clients on the issuer's system website. The reserve of assets that the issuer holds in oil or ETF funds substantiating electronic commodities securities currency of the clients will be stored in a vault. Free electronic commodities currency will be stored with the issuance corporation in wallets which the Operator of the system, that has been issued but not sold to the potential clients yet (free electronic commodities currency reserve, substantiated by the free reserve of assets which the issuer, holds e.g. oil reserve or ETF funds). The free reserve of assets that the issuer holds (e.g. oil or ETF funds) substantiating free electronic commodities securities currency which will be stored in a vault. The electronic commodities securities currency in the pre-issuance wallet of the Operator, which is generated but not issued into the system for circulation Free reserve of SHA currency and ECDSA based systems, stored on bank and brokers' accounts of the Operators. The system's reserves which the issuer holds will be (real funds)

### (51) Method of Calculating Currency

(52) The computer-based method for maintaining a reserve of assets which substantiates the issuer's electronic currency which will be continuously

monitored by a processor. This processor monitors and records the sufficiency and quantity of the reserve backing the crypto commodities currency based on the influx and number of orders placed for purchasing or
selling of the electronic commodities currency from
clients to the issuer At the point the amount of the assets that the issuer holds, in the reserve, reaches a break-even amount, which the processor will calculate. When this is realized the amount of assets that the issuer holds will be valued at the total shares in circulation backed by the total value of the assets that the issuer Currently holds backed by the value of the assets at the market price. This will be calculated and re-valued on a 30-day basis.

(53) The amount of the assets to be sold or purchased at an external market price which substantiates the electronic commodities currency is initiated by the processor in turn purchasing or selling the assets bought or sold in the reserve from an individual to the issuer's processor to an external market. In order to maintain a sufficient amount of reserve of assets on hand that backs our electronic commodities currency the enclosed formula will calculate the amount of assets to be sold or purchased from the external market at any given point in time.

(54) The value of assets held and circulated are calculated based upon the following formulas: MP=CM/Unit, CCM Ratio=MP/V Per Coin, A/MP=BH, A/SC=V Per Coin, TVA=(MP*BH), CCM=MP/V Per Coin, BE−B=SC/CCM, and BE−C=SC/BH, MPB=BH/A.
1) In the first quintessential aspect of the formula MP=CM/unit the variables MP and CM/unit are equal to each other. So, the market price of a container of oil is equal to the contribution margin per unit of the assets that the issuer holds at that point in time.
2) In the second quintessential formula CCM Ratio=MP/V per coin. The coin contribution margin is calculated as the market value of a container of oil which is divided by the value per coin of the total amount of coins available that the issuer holds on the cryptocurrency market.
3) In the third quintessential formula A/MP=BH the total amount of assets that the issuer holds at the given point in time is divided by the market value of a container of oil resulting in the total number of containers of oil held by the issuer at market value.
4) In the fourth quintessential formula A/SC=V Per Coin. The total amount of assets that the issuer holds at the certain point in time is divided by the total shares of coins available for sale on the cryptocurrency market released by the issuer This equals the value per coin.
5) In the fifth quintessential formula TVA=(MP*BH). The total value of assets that the issuer holds will be calculated by taking the market price of a container of oil multiplied by the total number of containers of oil held by the issuer at that certain point in time.
6) In the sixth quintessential formula BE−B=SC/CCM. The break-even in number of containers for the issuer is calculated by taking the shares of coins available for sale on the cryptocurrency market released by the issuer divided by the coin contribution margin. This yields in the break-even in containers for the issuer
7) In the seventh quintessential formula BE−C=SC/BH. The break-even in coins is calculated as the shares of coins available for sale on the cryptocurrency market released by the issuer divided by the number of containers held at that point in time by the issuer yielding in the break-even in coins for the issuer
8) In the eighth quintessential formula MPB=BH/A. The market price per container of oil is calculated as the number of containers of oil held by the issuer divided by the total value of assets on have at that point in time that the issuer has.

(55) The issuer will have the help of this mathematical model based on accounting principles to help maintain the reserve balance and the assets held by the issuer at that specific point in time. The above formulas will be calculated on a 30-day basis 12 times in the fiscal year. The system will also monitor all electronic commodities currency purchasing and selling from the clients or the system. Being monitored by a processor is not only more efficient for the overall business model but also for the reserve of assets held by the issuer The method for maintaining the reserve of assets that substantiate the electronic commodities currency the system wherein the electronic commodities currency circulates together with a number of fiat currencies is comprised of continuously being monitored the the issuer processor based on the amount of orders processed for purchasing or selling the electronic commodities currency for each number of fiat currencies based on the value of the United States Dollar (USD).

(56) When the amount of the assets in the reserve held by The issuer reaches a break-even amount, calculated, by the processor, for each of the number of fiat currencies the amount of the valued assets which are sold or purchased on an external market in order to substantiate the electronic commodities currency the valued amount of capital required will be calculate in order to carry out the remaining purchasing or selling of the portion of assets outstanding in the reserve Capital

(K) is calculated based upon the following formula: TWK=TA−TL, TWK−A=FV, FV/MP=FVBH, TFV=(MP*FVBH), TFV/SC=VC>A, FVB=FVBH/A, KQV=MP(VPC−VC>A), KPV=(MVB−FVB)*VC>A.
1) In the first quintessential capital formula TWK=TA−TL. The total working capital is equal to the total assets that The issuer holds at that point in time minus the total liabilities that The issuer has at that point in time.
2) In the second quintessential capital formula TWK−A=FV. The fundamental value is calculated as the total working capital of The issuer minus the assets that The issuer holds at that point in time.
3) In the third quintessential capital formula FV/MP=FVBH. The fundamental value is divided by the market price of a container of oil which will give The issuer the fundamental value of the total number of containers held based on the value of total working capital that The issuer has at this point in time.
4) In the fourth quintessential capital formula TFV=(MP*FVBH). The total fundamental value is calculated by taking the market price of a container of oil multiplied by the fundamental value of the total number of containers of oil held by The issuer
5) In the fifth quintessential capital formula TFV/SC=VC>A. The total fundamental value of capital is divided by the shares of coins available for sale on the cryptocurrency market released by The issuer which give The issuer the value per coin needed to turn into assets at that point in time.
6) In the sixth quintessential capital equation FVB=FVBH/A. The fundamental value of a container of oil is calculated by taking the fundamental value of the number of containers held by The issuer at that point in time divided by the total amount of assets valued in dollars.
7) In the seventh quintessential capital equation (this equation is imperative as it gives The issuer the actual variance needed for the amount of capital in quantity that would need to be transferred into electronic commodities cryptocurrency in order to cover the amount that was sold or processed past the break-even amount) KQV=MP*(VPC−VC>A). The capital quantity variance is calculated as the market price of a container of oil times the value per coin minus the value per coin needed to turn into assets at that point in time.
8) In the eighth quintessential capital equation (this equation is imperative as it gives The issuer the actual variance needed for the amount of capital in price that would need to be transferred into electronic commodities cryptocurrency in order to cover the amount that was sold or processed past the break-even amount) KPV=(MPB−FVB)*VC>A. The capital price variance is calculated by taking the market price of a container of oil minus the fundamental value of a container of oil and multiplying that by the value per coin needed to turn into assets at that point in time.

(57) The method for furthering the comprises in order to form free reserves by creating and maintaining reserve stocks in both the assets held and used by The issuer in order to substantiate the electronic commodities currency and also in the United States Dollar (USD) and also in multiple fiat currencies which will be stored on the operator's personal bank account.

(58) The amount of the assets that will be available in the free assets reserve held by The issuer will directly correspond to the fixed valued amount that is purchased or sold amount of the asset. In essence the fixed amount of assets that are able to be purchased or sold through the external market in leu to the amount of the current value of a fiat currency, the free fiat currency reserve will always directly correspond to the actual market value that backs the assets held by The issuer

(59) The total value or the free reserves will not be less than the market value and cost of the free reserve of assets which The issuer possesses.

(60) The majority of the overall purchases and sales of the electronic commodities currency will be conducted by the operator using the electronic commodities currency that is currently held in the operator's wallet with a minimum of one fiat currency being used for the transaction that will be from the operator's fiat currency reserve that they possess solely.

(61) The electronic commodities currency that is held in the operator's wallet en lieu of the fiat currency that is also held in the operator's wallet must be sufficient to the fiat currency reserve being carried out from the purchase or sale of the electronic commodities currency that is given to the operator which will be transferred via an online node or processor and carried out at the operator's

participation in such activities. The online transaction being carried out of the purchasing of the electronic
commodities currency from the external market. The issuing of the electronic commodities currency for the purchased amount of substantiation from the operation of selling the substantiation on the external market will result in the operation being completed and transferred to the wallet of the purchaser or the purchaser's bank account that is held with the seller of the electronic commodities currency.

(62) The operator that will hold the reserve of assets which will carry out operations of the purchasing by substantiation of the electronic commodities currency from the external market and issue the electronic commodities currency for the specific purchased amount from The issuer upon transferring that electronic commodities currency to the operator's wallet will also facilitate the overall operations of selling and or purchasing of the electronic commodities currency from the substantiation of the external market. Then in turn will transfer the profit of the sale to the operator's in the value of the fiat currency the is used at the current point in time that will be converted to United States Dollars (USD) to the wallet or bank account of the specific individual who holds an account with The issuer Therein the operations of purchasing or selling of the electronic commodities currency which is substantiated by the electronic commodities currency backed by the external market value will be initiated when the threshold amount of the substantiated electronic commodities currency is realized. Both of which will be calculated at that point in time.

(63) All of the assets sold by The issuer will be rounded to a certain value that is divisible by the fixed purchase or selling amount of the valued asset at that current point in time where the free reserve of assets on hand will be maintained at a threshold amount that will not be less than the fixed purchasing or selling amount of the assets that are on hand. This is measured based on the combination of the value of the assets that The issuer holds from multiple currency equivalents as well as conversion formulas. If a decrease in the amount of assets that The issuer holds from the free reserved decreases to a level that is lower than the calculated threshold amount. The purchase order for the electronic commodities currency that is received will be transferred to the offline node or processor where the continuation of the purchasing operations will occur. In the case where there is a decrease in the actual fiat currency the free fiat currency reserve will be valued to a level which will be lower than the threshold amount of the specific order or orders in order to successfully sell the electronic commodities currency that is received by The issuer All recording of the selling and purchasing operations will also be transferred and backed up by an online node or processor as well as the processor that The issuer will hold.

### Terms of Network Governance:

(64) The issuer provides the following definitions as an aid for the understanding of the detailed document and its description of the claims that are present in the document for the release and implementation of the inventions that are enclosed within this document. All of the definitions that are provided by the issuer will apply throughout all of the specifications and claims that the issuer is making throughout this document. This will not apply in any instance where any individual that has the applicable skill level to understand and able to apply the concepts and context of the document.
1) Electronic currency—The expression of value, that has or does not have a certain amount of a real valued (money, oil, commodities, or other assets) that is equivalent to and is also accepted as a form of payment by the means of an electronic settlement system.
2) Cryptocurrency—A electronic currency where the issuance and circulation will be carried out via the use of crypto technologies or blockchain technology that has been developed and is currently in use or accepted by market standards.
3) Mining—A term that is applicable and coined and redefined for the action of maintaining a distributed network that creates new blocks. The existing systems that are built on the principles of blockchain technology which process the generating cryptocurrency that is connected to the specific mining of the specified currency. The currency units are created and mined which are in turn returned to the original holdings corporation as a monetary reward or in the likeness thereof for the creating of new blocks in the system that has been developed and added to the overall block network of the crypto market.
4) Operator—Any entity that takes control and monitors and facilitates the issuance of the electronic commodities currency that limits the circulation of the system. This includes the management of all the reserve amounts and their prescribed values. An operator may be any individual that The issuer has approved and vetted and has employed to monitor all economic and legal activity that The issuer will monitor from any individual who holds an account or does business with.
5) Issuing center—The department of the system which is responsible for the issuance of the electronic commodities currency that will be put into circulation and that of which will be backed by the reserve of assets on hand that substantiates the electronic commodities currency held by The issuer
6) Primary issuance—The initial issuance of the electronic commodities currency from The issuer i.e. the operator's wallet to the clients wallet. This substantiation is always provided by the operator (which is approved by The issuer as an official operator) that carries out the initial launching of the system and issuance of the electronic commodities currency.
7) Continuing issuance—The overall issuance of electronic commodities currency that will be carried out during the continuation of the processes after the primary issuance of the electronic commodities currency from the system's initial operation. This will ultimately satisfy the demand for electronic commodities currency predicated on the basis of orders that will be received by The issuer from the clientele of The issuer
8) Operator's wallet—The virtual storage device which all data is stored on that will be utilized for the accounting of the valuables or assets that The issuer holds belonging to the system administration operator.
9) Client's wallet—The virtual storage device which all data is stored on that will be utilized by the client of The issuer which will be used for the accounting the valuables or assets that The issuer will sell to the client.
10) Transaction—The act of transferring a specified amount of a valuable asset i.e. oil or ETF shares via the electronic commodities currency in which the specified commodity and all rights of ownership for the property and also the intellectual property transferred which will be recorded on the The issuer's servers and also backup servers via the The issuer system's database.
11) Settlement network—a system of recording transactions between the operator and also The issuer's clients. This will include the clients' transactions that are carried out from client to client. This network will also settle any discrepancies and disputes that each client of The issuer might have with the system and its processes. The settlement network will be a distributed network that will operate solely on the basis of the blockchain technology system developed by The issuer
12) Data center—The primary server center that will be set up and managed by The issuer through a distributed settlement network which will function as a storage and data management and back-up center of all the virtual data from the transactions that will be carried out on the The issuer system and monitored servers.

### BRIEF DESCRIPTION OF DRAWINGS

FIG. 1. Is the claimed use of an elliptical curve digital signature algorithm

FIG. 1a. Shows the cod a java implementation of an elliptical curve as it pertains to blockchain

FIG. 1b. Is the public/private key output in a string of text from the ECDSA algorithm

FIG. 2. Outlines a blockchain network with nodes, users, and an issuer

FIG. 2a. Shows the use of ANCOVA covariance models to allocate a specific amount of crude oil to a container.

FIG. 3. Shows the details of a centralized issuance center managing a decentralized currency network.

FIG. 4. Details a blockchain time stamp and transactional system sending currency from one user to another and broadcasting the transaction to the network.

FIG. 5. Illustrates the steps in linking shares from an electronically traded fund (ETF) to a liquid digital currency.

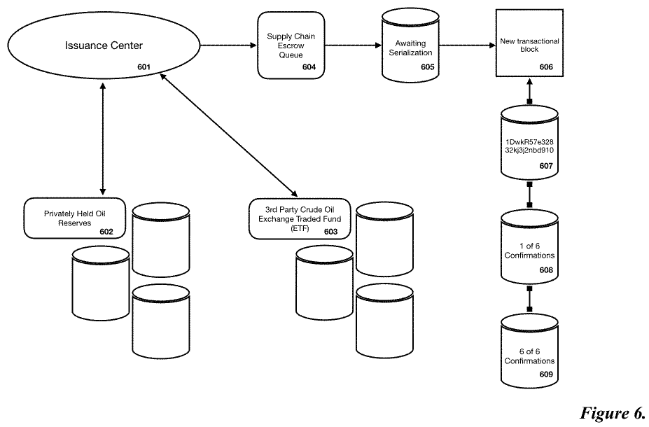

FIG. 6. Illustrates the central issuance center associating crude oil reserves with serialized barrels on a blockchain network

What is claimed herein this application:

1. Claim 1 is the use of an elliptical curve digital signature algorithm to create and secure encryption key pairs in the use case of a crude oil backed digital asset.

2. Claim 2 is the use of petroleum oriented analysis of covariance models (ANCOVA).

3. Claim 3 outlines an issuer purchasing an initial reserve of physical oil or ETF shares from a broker or a seller via contract.

4. Claim 4 is the use of public and private keys derived from an ECDSA algorithm being implemented at large in an online blockchain.

5. Claim 5 represents the electronic currency issuer purchasing an initial reserve or stock of crude oil, or exchange traded fund (ETF) shares of a crude oil asset from a broker or a seller.
